(19) United States
(12) Patent Application Publication
(10) Pub. No.: US 2021/0335134 A1
(43) Pub. Date: Oct. 28, 2021

(54) VEHICLE CONTROL DEVICE AND VEHICLE INCLUDING THE SAME

(71) Applicant: LG Electronics Inc., Seoul (KR)

(72) Inventors: Suho PARK, Seoul (KR); Hyunho KI, Seoul (KR); Hansung KIM, Seoul (KR); Jaeseung BAE, Seoul (KR); Changhun SUNG, Seoul (KR); Jaehwan YOON, Seoul (KR)

(21) Appl. No.: 16/490,406

(22) PCT Filed: Feb. 22, 2019
(86) PCT No.: PCT/KR2019/002224

§ 371 Date: Aug. 30, 2019

(51) Int. Cl. G08G 1/00; B60W 60/00; B60W 30/16

(52) U.S. Cl. CPC G08G 1/22; B60W 60/0027; B60W 30/16; B60W 2554/80; B60W 2552/00; B60W 2554/404; B60W 2556/65

(57) ABSTRACT

The present invention provides a vehicle control device for controlling a vehicle. The vehicle control device includes a communication unit configured to communicate with one or more follow vehicles set as a group, and a processor configured to transmit vehicle driving information via the communication unit so that platooning is performed with the one or more follow vehicles, wherein the processor, in response to any one of the follow vehicles deviating from the group, generates a control message so that at least one of the follow vehicles drives at different distances apart from each other according to a deviation characteristic of any one of the follow vehicles.

### TECHNICAL FIELD

The present invention relates to a vehicle control device capable of controlling at least one of a vehicle and electronic components provided in the vehicle, and a vehicle including the same.

### BACKGROUND

A vehicle refers to means of transporting people or goods by using kinetic energy. Representative examples of vehicles include automobiles and motorcycles.

For safety and convenience of a user who uses the vehicle, various sensors and devices are provided in the vehicle, and functions of the vehicle are diversified.

The functions of the vehicle may be divided into a convenience function for promoting driver's convenience, and a safety function for enhancing safety of the driver and/or pedestrians.

First, the convenience function has a development motive associated with the driver's convenience, such as providing infotainment (information+entertainment) to the vehicle, supporting a partially autonomous travel function, or helping the driver ensuring a field of vision at night or at a blind spot. For example, the convenience functions may include various functions, such as an active cruise control (ACC), a smart parking assist system (SPAS), a night vision (NV), a head up display (HUD), an around view monitor (AVM), an adaptive headlight system (AHS), and the like.

The safety function is a technique of ensuring safeties of the driver and/or pedestrians, and may include various functions, such as a lane departure warning system (LDWS), a lane keeping assist system (LKAS), an autonomous emergency braking (AEB), and the like.

In addition, there is a platooning function in which a plurality of vehicles may maintain close to each other via a vehicle distance control to drive in one platoon (or group). The plurality of vehicles may exchange the moving of the vehicles and potentially abnormal situation information in the group via communication between the vehicles, and maintain the vehicle distance through the control according thereto.

When the platooning is performed, the fuel of the vehicles included in the group is saved, and since the distance between the vehicles is maintained narrow, the road occupancy rate of the vehicles is reduced and the congestion is mitigated.

The platooning may be performed through vehicle-to-everything communication (or V2X) or vehicle-to-vehicle communication (V2V). The group of the platooning includes a leader vehicle positioned at a forefront of the group and a follow vehicle following the leader vehicle. One or more follow vehicles receive driving information of the leader vehicle and move along the leader vehicle.

In general, the group is made by a group request of the follow vehicle and a group approval of the leader vehicle. Since the leader vehicle shares its own vehicle travel information, which may be called personal information, with the follow vehicle, approval is required. Requests and approvals are triggered by a user input of a passenger boarded on the vehicle.

The platooning has many advantages, but it is not popularized in that it requires requests and approvals between the passengers boarded on the leader vehicle and the follow vehicle.

### DISCLOSURE

### Technical Problem

The present invention is directed to solving the above-described problems and other problems.

The present invention is directed to providing a vehicle control device capable of inducing a safe deviation from a deviating vehicle without releasing a group of platooning vehicles and a vehicle including the same when at least one of the platooning vehicles suddenly deviates from the group.

### Technical Solution

The present invention relates to a vehicle control device for controlling a vehicle, a vehicle including the same, and a vehicle control method for a vehicle communication system including a plurality of vehicles.

A vehicle control device according to one embodiment includes: a communication unit configured to communicate with one or more follow vehicles set as a group; and a processor configured to transmit vehicle travel information via the communication unit so that platooning is performed with the one or more follow vehicles, wherein the processor, in response to any one of the follow vehicles deviating from the group, generates a control message so that at least one of the follow vehicles drives at different distances apart from each other according to a deviation characteristic of any one of the follow vehicles.

According to one embodiment, in response to the deviation characteristic satisfying a first deviation condition, the processor may generate a control message so that at least one of vehicles drives at a first distance apart, and in response to the deviation characteristic satisfying a second deviation condition, the processor may generate a control message so that at least one of follow vehicles drives at a second distance that is narrower than the first distance apart.

According to one embodiment, the first deviation condition may be defined as any one of the follow vehicles deviating from the group at manual driving, and the second deviation condition may be defined as any one of the follow vehicles deviating from the group at autonomous driving.

According to one embodiment, the first deviation condition may be defined as any one of the follow vehicles deviating from the group according to a control of the processor, and the second deviation condition may be defined as any one of the follow vehicles deviating from the group regardless of the control of the processor.

According to one embodiment, in response to the deviation of any one of the follow vehicles satisfying a predetermined condition, the processor may transmit a deviation approval message to any one of the follow vehicles.

According to one embodiment, the processor may receive the vehicle travel information from one or more electric components provided in the vehicle via the communication unit, and determine whether the deviation of any one of the follow vehicles satisfies the predetermined condition based on the vehicle travel information.

According to one embodiment, the processor may receive follow vehicle travel information from the follow vehicles via the communication unit, and determine whether the deviation of any one of the follow vehicles satisfies the predetermined condition based on the vehicle travel information and the follow vehicle travel information.

According to one embodiment, control authority restricted to a driver boarded on any one of the follow vehicles may be released by the deviation approval message.

According to one embodiment, the processor may receive the vehicle travel information from one or more electric components provided in the vehicle via the communication unit, and determine whether the deviation characteristic satisfies the first deviation condition or the second deviation condition based on the vehicle travel information.

According to one embodiment, the processor may determine whether the deviation characteristic satisfies the first deviation condition or the second deviation condition based on a message received from any one of the follow vehicles.

According to one embodiment, in response to any one of the follow vehicles deviating from the group, the processor may set a sub-group, a sub-leader vehicle leading the sub-group, and a sub-follow vehicle following the sub-leader vehicle.

According to one embodiment, when the sub-group is set, the processor may limit transmitting of the vehicle travel information to the sub-follow vehicle.

According to one embodiment, when the sub-group is released, the transmitting of the vehicle travel information to the sub-follow vehicle may be resumed.

According to one embodiment, the processor may release the sub-group based on a distance between the sub-leader vehicle and a vehicle positioned in front of the sub-leader vehicle.

According to one embodiment, the processor may select any one of the follow vehicles as the sub-leader vehicle based on at least one of a position, a type, a height, a length, and a speed of each follow vehicle.

According to one embodiment, the processor may set any one of the follow vehicles as a next leader vehicle, and when deviation of the vehicle is scheduled in the group, the deviation of the vehicle may be restricted until platooning is performed by the next leader vehicle.

According to one embodiment, the restriction of control authority assigned to a driver boarded on the vehicle may be included in the restriction of the deviation of the vehicle.

According to one embodiment, when any one of the follow vehicles is scheduled to deviate from the group during platooning while being spaced apart from each other within a first predetermined range, the processor may control the communication unit so as to perform the platooning while being spaced apart from each other within a second predetermined range wider than the first predetermined range.

According to one embodiment, the second predetermined range may vary depending on a road on which the vehicle is driving.

According to one embodiment, when deviation of the follow vehicle is completed, the processor may control the communication unit so that the deviating vehicle is spaced apart from each other within the first predetermined range that is not the second predetermined range to perform the platooning.

### Advantageous Effects

Effects of a vehicle control device for controlling a vehicle, a vehicle including the same, and a vehicle control method of a vehicle communication system including a plurality of vehicles in the present invention will be described as follows.

When a deviating vehicle deviating from a group occurs, a safe deviation of the deviating vehicle may be induced by adjusting a distance between platooning vehicles while a group of the platooning vehicles is not released. In addition, since the distance between the platooning vehicles varies depending on a deviation characteristic of the deviating vehicle, stability of the platooning vehicles is further enhanced.

When the distance between the platooning vehicles becomes far apart and communication becomes impossible, a sub-group is generated and platooning of the sub-group is performed by a sub-leader vehicle, and thus the group may be maintained.

### BRIEF DESCRIPTION OF THE DRAWINGS

FIG. 1 is a block diagram for describing a vehicle control device according to the present invention.

FIG. 2 is a block diagram for describing a vehicle control device for controlling a plurality of vehicles

FIG. 3 is a flowchart for describing an operation of a leader vehicle, a follow vehicle, and a potential follow vehicle for platooning.

FIG. 4 is a flowchart for describing an operation of a vehicle control device for controlling a vehicle.

FIG. 5 is a flowchart for describing a method of transmitting a deviation approval message to a deviating vehicle deviating from a group.

FIG. 6 is a flowchart for describing a method of setting a sub-group in response to occurrence of a deviating vehicle.

FIG. 7 is a conceptual diagram describing the method in more detail described in FIG. 6.

FIG. 8 is a flowchart for describing an operation of a vehicle control device when a leader vehicle deviates.

FIG. 9 is a flowchart for describing a method of controlling an operation of platooning vehicles when the vehicle deviates.

### MODES FOR CARRYING OUT THE PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle according to an embodiment of the present invention may be understood as a conception including cars, motorcycles and the like. Hereinafter, the vehicle will be described based on a car.

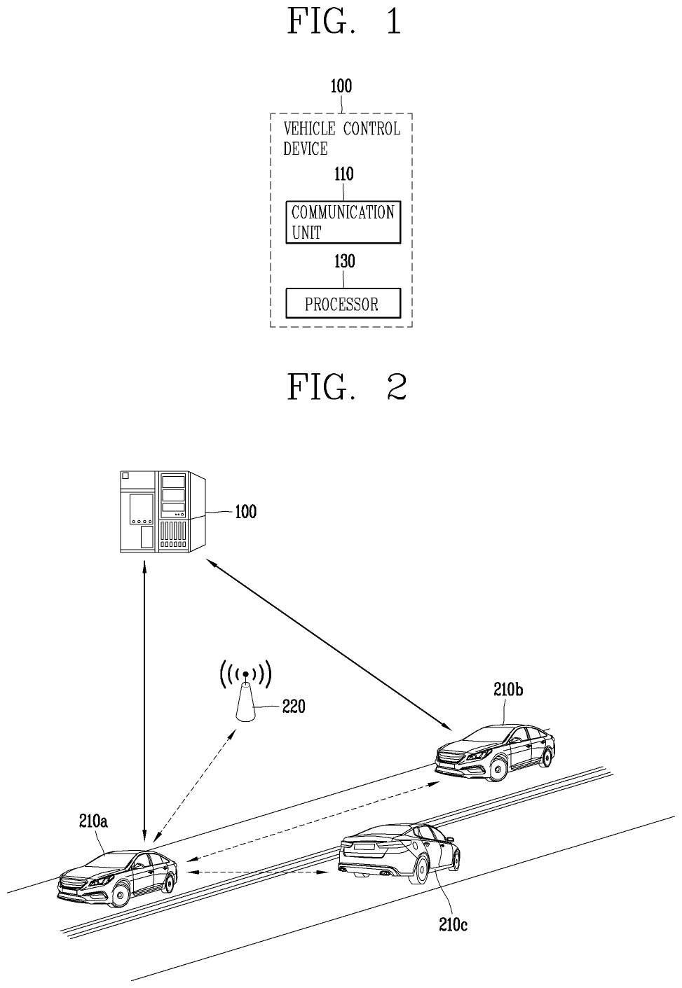

FIG. 1 is a block view illustrating a vehicle control device according to an embodiment of the present invention.

The vehicle control device refers to a device for controlling the vehicle.

For example, the vehicle control device may be a device mounted on a vehicle to perform communication through CAN communication and generate messages for controlling the vehicle and/or electric components mounted on the vehicle.

As another example, the vehicle control device may be located outside the vehicle, like a server or a communication device, and may perform communication with the vehicle through a mobile communication network. In this case, the vehicle control device can remotely control the vehicle and/or the electric components mounted on the vehicle using the mobile communication network.

The vehicle control device 100 is provided in the vehicle, and may be implemented as an independent device detachable from the vehicle or may be integrally installed on the vehicle to construct a part of the vehicle 100.

Referring to FIG. 1, the vehicle control device 100 includes a communication unit 110 and a processor 130.

The communication unit 110 is configured to perform communications with various components provided in the vehicle. For example, the communication unit 110 may receive various information provided through a controller area network (CAN). In another example, the communication unit 110 may perform communication with all devices capable of performing communication, such as a vehicle, a mobile terminal, a server, and another vehicle. This may be referred to as Vehicle to everything (V2X) communication. The V2X communication may be defined as a technology of exchanging or sharing information, such as traffic condition and the like, while communicating with a road infrastructure and other vehicles during driving.

The communication unit 110 may receive information related to the travel of the vehicle from most of electric components in the vehicle 100. The information transmitted from the electric component provided in the vehicle to the vehicle control device 100 is referred to as ‘vehicle driving information (or vehicle travel information)’.

Vehicle travel information includes vehicle information and surrounding information related to the vehicle. Information related to an inside of the vehicle with respect to a frame of the vehicle 100 may be defined as the vehicle information, and information related to an outside of the vehicle may be defined as the surrounding information.

The vehicle information refers to information related to the vehicle itself. For example, the vehicle information may include a traveling speed, a traveling direction, an acceleration, an angular velocity, a location (GPS), a weight, a number of passengers in the vehicle, a braking force of the vehicle, a maximum braking force, air pressure of each wheel, a centrifugal force applied to the vehicle, a travel mode of the vehicle (autonomous travel mode or manual travel mode), a parking mode of the vehicle (autonomous parting mode, automatic parking mode, manual parking mode), whether or not a user is present in the vehicle, and information associated with the user.

The surrounding information refers to information related to another object located within a predetermined range around the vehicle, and information related to the outside of the vehicle. The surrounding information of the vehicle may be a state of a road surface on which the vehicle is traveling (e.g., a frictional force), the weather, a distance from a front-side (rear-side) vehicle, a relative speed of a front-side (rear-side) vehicle, a curvature of a curve when a driving lane is the curve, information associated with an object existing in a reference region (predetermined region) based on the vehicle, whether or not an object enters (or leaves) the predetermined region, whether or not the user exists near the vehicle, information associated with the user (for example, whether or not the user is an authenticated user), and the like.

The surrounding information may include ambient brightness, temperature, a position of the sun, information related to nearby subject (a person, another vehicle, a sign, etc.), a type of a driving road surface, a landmark, line information, and driving lane information, and information required for an autonomous travel/autonomous parking/automatic parking/manual parking mode.

In addition, the surrounding information may further include a distance from an object existing around the vehicle to the vehicle, collision possibility, a type of an object, a parking space for the vehicle, an object for identifying the parking space (for example, a parking line, a string, another vehicle, a wall, etc.), and the like.

The vehicle travel information is not limited to the example described above and may include all information generated from the components provided in the vehicle.

Meanwhile, the processor 130 is configured to control one or more electric components provided in the vehicle using the communication unit 110.

Specifically, the processor 130 may determine whether or not at least one of a plurality of preset conditions is satisfied, based on vehicle travel information received through the communication unit 110. According to a satisfied condition, the processor 130 may control the one or more electric components in different ways.

In connection with the preset conditions, the processor 130 may detect an occurrence of an event in an electric component provided in the vehicle and/or application, and determine whether the detected event meets a preset condition. At this time, the processor 130 may detect the occurrence of the event from information received through the communication unit 110.

The application is a concept including a widget, a home launcher, and the like, and refers to all types of programs that can be run on the vehicle. Accordingly, the application may be a program that performs a function of a web browser, a video playback, a message transmission/reception, a schedule management, or an application update.

Further, the application may include a forward collision warning (FCW), a blind spot detection (BSD), a lane departure warning (LDW), a pedestrian detection (PD) A Curve Speed Warning (CSW), and a turn-by-turn navigation (TBT).

For example, the event occurrence may be a missed call, presence of an application to be updated, a message arrival, start on, start off, autonomous travel on/off, pressing of an LCD awake key, an alarm, an incoming call, a missed notification, and the like.

As another example, the occurrence of the event may be a generation of an alert set in the advanced driver assistance system (ADAS), or an execution of a function set in the ADAS. For example, the occurrence of the event may be a occurrence of forward collision warning, an occurrence of a blind spot detection, an occurrence of lane departure warning, an occurrence of lane keeping assist warning, or an execution of autonomous emergency braking.

As another example, the occurrence of the event may also be a change from a forward gear to a reverse gear, an occurrence of an acceleration greater than a predetermined value, an occurrence of a deceleration greater than a predetermined value, a change of a power device from an internal combustion engine to a motor, or a change from the motor to the internal combustion engine.

In addition, even when various electronic control units (ECUs) provided in the vehicle perform specific functions, it may be determined as the occurrence of the event.

For example, when a generated event satisfies the preset condition, the processor 130 may control the communication unit 110 to display information corresponding to the satisfied condition on one or more displays provided in the vehicle.

Meanwhile, the vehicle control device 100 may perform a function related to platooning in which a plurality of vehicles form a group.

For example, a leader vehicle of the group may transmit its own vehicle travel information to a follow vehicle included in the group. For another example, a follow vehicle in the group may perform platooning based on the vehicle travel information received from the leader vehicle. The vehicle control device provided in the follow vehicle may transmit a control message to one or more electronic components provided in the follow vehicle based on the vehicle travel information of the leader vehicle.

The communication unit 110 of the vehicle control device 100 is configured to perform communication with other vehicles positioned within a predetermined range. For example, the predetermined range may be a communicable distance for performing the platooning.

The processor 130 performs the communication with the other vehicles via the communication unit so as to perform the platooning. The processor 130 may share the vehicle travel information of its own vehicle with the other vehicle, or may receive the vehicle travel information of the other vehicle to use it for the platooning.

FIG. 2 is a block diagram for describing a vehicle control device for controlling a plurality of vehicles.

The vehicle control device 100 may be mounted on a vehicle to control the vehicle, and may control the vehicle remotely using a wireless network in a state in which the vehicle control device 100 is not mounted on the vehicle.

The communication unit 110 is configured to perform controller area network (CAN) communication when the vehicle control device 100 is mounted on the vehicle, and may be configured to perform wireless communication via a wireless network 220 when the vehicle control device 100 is not mounted on the vehicle. In other words, the communication unit 110 may be configured to perform different methods of communication according to the type of the vehicle control device.

The vehicle control device 100 may correspond to a server, a base station, or an infrastructure of V2I, and may communicate with one or more vehicles 210a to 210c and may generate a control message for controlling each vehicle.

For example, the vehicle control device 100 may receive first vehicle travel information generated at a first vehicle 210a from the first vehicle 210a, and generate a control message for controlling the first vehicle 210a based on the first vehicle travel information.

The control message may be associated with various control functions such as, setting a destination of the first vehicle 210a, changing a driving mode, controlling a brake, engine, motor, etc. so that speed is changed, controlling a steering device so that a driving direction is changed, or the like.

Hereinafter, an operation of the vehicle control device 100 will be described in more detail with reference to the accompanying drawings.

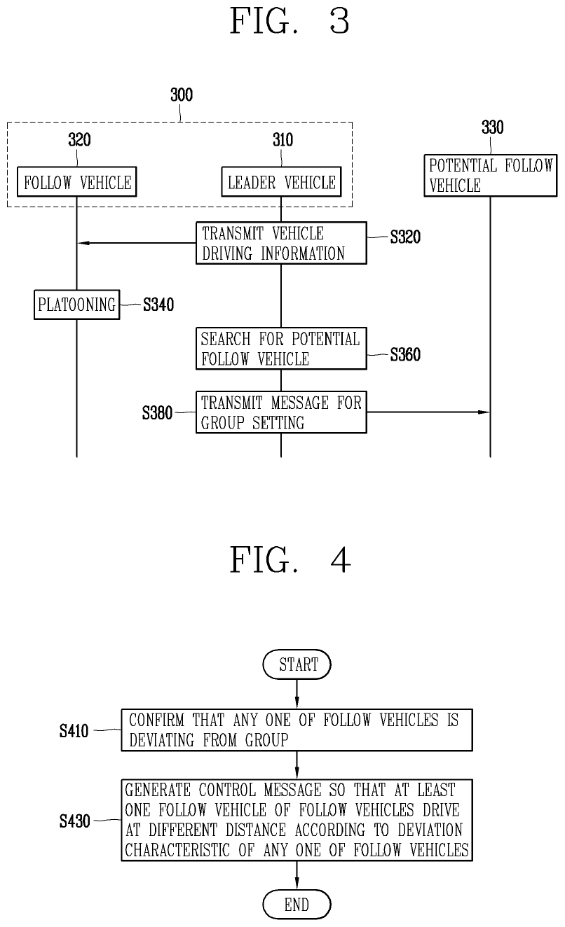

FIG. 3 is a flowchart for describing an operation of a leader vehicle, a follow vehicle, and a potential follow vehicle for platooning.

Platooning refers to driving such that the distance between a front vehicle and a rear vehicle among a plurality of vehicles consecutively positioned is maintained within a predetermined range. The plurality of vehicles drive in one group, and consist of a leader vehicle positioned at a forefront and one or more follow vehicles that follow the leader vehicle.

Vehicles 310 and 320 included in a group 300 are each provided with the above-described vehicle control device 100 in FIG. 1, and share vehicle travel information generated from each vehicle via the communication unit 110 of the vehicle control device 100.

As disclosed below, an operation of the leader vehicle 310 is performed by a processor 130 of the vehicle control device 100 provided in the leader vehicle 310 and an operation of the follow vehicle 320 is performed by the processor 130 of the vehicle control device 100 provided in the leader vehicle 310.

One group 300 includes one leader vehicle 310 and at least one follow vehicle 320.

The leader vehicle 310 is positioned at the forefront of the group 300, and transmits its own vehicle travel information to the follow vehicle 320 included in the group 300 via inter-vehicle communication (V2X) (S320).

For example, the vehicle travel information of the leader vehicle 310 including a speed, acceleration, a driving direction and the like of the leader vehicle 310 may be transmitted to the follow vehicle 320.

The follow vehicle 320 performs the platooning following (or tracking) the leader vehicle 310 by using the vehicle travel information of the leader vehicle 310 received from the leader vehicle 310 (S340).

The follow vehicle 320 performs the driving so as to maintain a predetermined distance from the preceding vehicle. For example, a speed of the follow vehicle 320 may be adjusted by accelerating or decelerating so that a distance of 10 m or less from the preceding vehicle is maintained. A speed of the follow vehicle 320 may be adjusted or a driving radius may be changed by using the vehicle travel information of the leader vehicle 310 received from the leader vehicle 310.

The follow vehicle 320 may determine a predetermined speed and a predetermined driving direction at predetermined coordinates by using the vehicle travel information of the leader vehicle 310. When the follow vehicle 320 is positioned at the predetermined coordinates, control is performed so as to have the predetermined speed and the predetermined driving direction.

The leader vehicle 310 may communicate with vehicles positioned within a predetermined range, and search for a potential follow vehicle that coincides with at least part of the moving path of the leader vehicle 310 (S360). One or more potential follow vehicles may be searched.

A potential follow vehicle 330 is defined as a vehicle that may or should be the follow vehicle 320. The potential follow vehicle 330 may be searched by the leader vehicle 310. Alternatively, any of vehicles may transmit a group request message to the leader vehicle 310 to become a potential follow vehicle 330. The leader vehicle 310 may respond to the group request message to include any of the vehicles in the potential follow vehicle 330.

The leader vehicle 310 may search for a potential follow vehicle based on sensing information sensed by a sensor provided in the leader vehicle 310. In addition, the potential follow vehicle may be searched by using the inter-vehicle communication (V2X), or the potential follow vehicle may be searched by using the telematics communication.

The leader vehicle 310 may search for a potential follow vehicle that coincides with at least part of the moving path of the leader vehicle 310 based on a road on which the leader vehicle 310 is driving. For example, when another vehicle travel on the same road in the same direction within a predetermined range is sensed, the other vehicle may be searched as a potential follow vehicle based on the sensing information.

In another example, a destination of the other vehicle and/or a moving path of the other vehicle may be received by the inter-vehicle communication, and a potential follow vehicle that coincides with at least part of the moving path of the leader vehicle 310 may be searched based on received information. The leader vehicle 310 may receive other vehicle information including at least one of a destination and an expected moving path of each vehicle from vehicles positioned within a predetermined range. In addition, based on the other vehicle information, a potential follow vehicle in which at least part of the moving path of the leader vehicle 310 coincides may be searched.

As still another example, the leader vehicle 310 may communicate with a server that receives a path of each vehicle. The leader vehicle 310 may transmit its position to the server, and the server may search for a potential follow vehicle coinciding with at least part of the moving path based on the position of the leader vehicle 310 to transmit it to the leader vehicle 310. The leader vehicle 310 may search for the potential follow vehicle based on information received from the server.

At least one of a size and shape of the predetermined range may vary depending on a speed of the leader vehicle 310. For example, when the speed of the leader vehicle 310 is within a first range, a predetermined range of a first size is set, but when the speed of the leader vehicle 310 is within a second range faster than the first range, a predetermined range of a second size smaller than the first size may be set. This is to ensure higher safety because as the speed of the vehicle increases, the risk of an accident that may occur in the vehicle increases.

The leader vehicle 310 may transmit a message so that the leader vehicle 310 and the potential follow vehicle 330 are set as one group in response to the search for the potential follow vehicle 330 (S380).

Specifically, the message may be transmitted to the potential follow vehicle 330 via the communication unit 110 of the vehicle control device 100 provided in the leader vehicle 310.

The message may include various information necessary for the potential follow vehicle 330 to be included in the group. For example, ID and security code of the leader vehicle 310 necessary for communication with the leader vehicle 310, and the vehicle travel information of the leader vehicle 310 may be included.

Hereinafter, an operation of a vehicle control device 100 for controlling at least one of a leader vehicle 310 and a follow vehicle 320 included in the group will be described in detail.

The vehicle control device 100 may be mounted on the leader vehicle 310, or may correspond to a server, a base station, or an infrastructure of V2I. Hereinafter, for convenience of description, an example will be described in which the vehicle control device 100 is mounted on the leader vehicle 310 to performs various controls related to the leader vehicle 310.

FIG. 4 is a flowchart for describing an operation of a vehicle control device for controlling a vehicle.

As described above with reference to FIG. 1, the vehicle control device 100 includes a communication unit 110 and a processor 130.

The communication unit 110 communicates with one or more follow vehicles set as a group.

The processor 130 may receive vehicle travel information of a vehicle controlled by the vehicle control device 100 from one or more electric components provided in the vehicle via the communication unit 110.

Further, the processor 130 may receive follow vehicle travel information generated in a follow vehicle, from the follow vehicle via the communication unit 110.

The processor 130 transmits the vehicle travel information to the one or more follow vehicles via the communication unit 110 so that platooning with the one or more follow vehicles is performed.

The processor 130 may confirm that any one of the follow vehicles deviates from the group (S410).

A vehicle which is either deviating from or scheduled to deviate from the group among the follow vehicles included in the group is defined as a ‘deviating vehicle’.

The processor 130 may sense that the deviating vehicle deviates from the group based on the vehicle travel information of the vehicle controlled by the vehicle control device 100 from one or more electric components provided in the vehicle.

The vehicle travel information may include sensing information sensed by various sensors and an image generated by an image sensor. The processor 130 may sense that the deviating vehicle deviates from the group by deviating from a lane on which the group is driving, or driving at a speed, not a regulated speed which is set to the platooning, based on the vehicle travel information.

The processor 130 may receive the follow vehicle travel information generated from the follow vehicle from at least one follow vehicle included in the group, and sense the deviating vehicle based on the follow vehicle travel information. In addition, the processor 130 may sense the deviating vehicle based on deviating vehicle travel information received from the deviating vehicle.

Here, the ‘follow vehicle travel information’ is defined as vehicle travel information generated from one or more electric components provided in the follow vehicle, and the ‘deviating vehicle travel information’ is defined as vehicle travel information generated from one or more electric components provided in the deviating vehicle.

The deviating vehicle may report to the vehicle control device 100 via the message that the vehicle is deviating from its own group or that the vehicle is scheduled to deviate from its own group.

Next, the processor 130 may generate a control message so that at least one follow vehicle of the follow vehicles drives at different distances apart according to a deviation characteristic of any one of the follow vehicles (S430).

In response to any one of the follow vehicles deviating from the group, the processor 130 may generate a control message so that at least one follow vehicle of the follow vehicles drives at different distances apart according to the deviation characteristic of any one of the follow vehicles.

For example, in response to the deviation characteristic satisfying a first deviation condition, the processor may generate a control message so that at least one of vehicles drives at a first distance apart, and in response to the deviation characteristic satisfying a second deviation condition, the processor may generate a control message so that at least one of follow vehicles drives at a second distance that is narrower than the first distance apart.

The deviation characteristic may be set variously according to an embodiment.

For example, the first deviation condition may be defined as any one of the follow vehicles deviating from the group at manual driving, and the second deviation condition may be defined as any one of the follow vehicles deviating from the group at autonomous driving.

The deviation from the group at the manual driving may include that a driver boarded on the follow vehicle operates a steering wheel to change a driving lane of the follow vehicle to a lane different from the lane on which the group is driving. When the driver presses an accelerator pedal to accelerate a speed of the follow vehicle or when the driver presses a brake to decelerate the speed of the follow vehicle, the follow vehicle may be included in a case in which the follow vehicle deviates from the group at the manual driving.

For another example, the first deviation condition may be defined as any one of the follow vehicles deviating from the group according to a control of the processor, and the second deviation condition may be defined as any one of the follow vehicles deviating from the group regardless of the control of the processor.

The follow vehicle may transmit a request for deviating from the group to the leader vehicle based on a request of a passenger, a change of destination, or a moving path. In this case, the processor 130 may control the communication unit 110 so that the follow vehicle deviates from the group. In this case, the processor 130 may determine that the follow vehicle deviates from the group according to the control of the processor 130.

On the other hand, the follow vehicle may deviate from the group regardless of the control of the processor by a driving operation of the driver. In this case, the processor 130 may determine that deviation satisfying the second deviation condition has occurred.

The processor 130 may receive the vehicle travel information from one or more electric components provided in the vehicle via the communication unit 110, and determine whether the deviation characteristic satisfies the first deviation condition or the second deviation condition based on the vehicle travel information.

The processor 130 may determine whether the characteristic of the deviating vehicle satisfies the first deviation condition or the second deviation condition based on a message received from the deviation vehicle.

The platooning vehicles during platooning are spaced apart from each other within a first predetermined range to perform the platooning. When the deviation during the platooning occurs due to intervention of the driver, in order to ensure safety of the platooning vehicles, the platooning vehicles except for the deviating vehicle are spaced apart from each other within a second predetermined range to perform the platooning. Since the platooning is performed at a wider distance than the first predetermined range in order to avoid the deviating vehicle, a risk of an accident caused by the deviating vehicle may be reduced. On the other hand, when the deviation due to the control of the processor 130 occurs, since the vehicle distance is controlled by the processor 130, the platooning vehicles are spaced apart from each other within a third predetermined range to perform the platooning. At this point, the third predetermined range is shorter than the second predetermined range, and is longer than the first predetermined range.

As described above, the vehicle distance of at least one of the platooning vehicles is controlled variably depending on the deviation characteristic when the deviating vehicle occurs, and thus safe platooning may be performed while maintaining the group. Further, a safe deviation of the deviating vehicle may be induced.

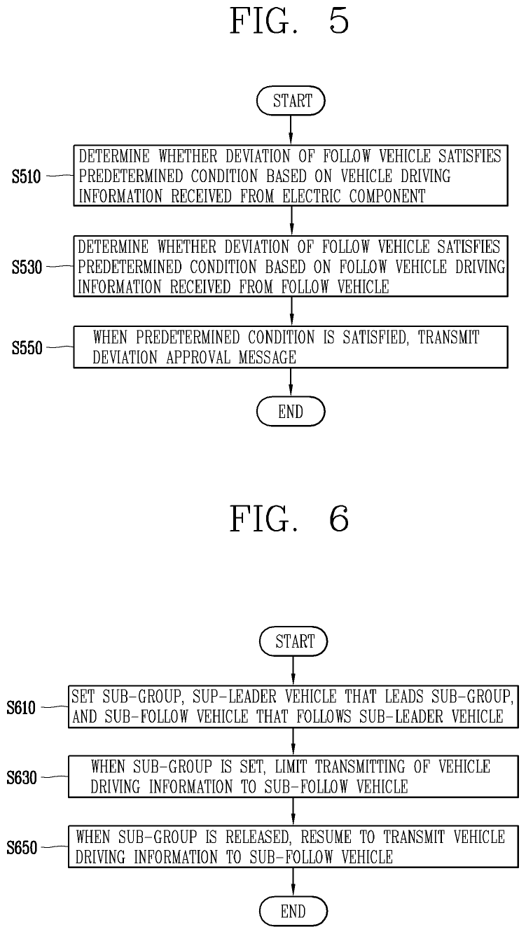

FIG. 5 is a flowchart for describing a method of transmitting a deviation approval message to a deviating vehicle deviating from a group.

The processor 130 may selectively transmit the deviation approval message depending on whether deviation of the deviating vehicle satisfies a predetermined condition.

Here, the predetermined condition denotes a condition that a driving operation may be performed by the driver of the deviating vehicle.

For example, when the follow vehicle following the deviating vehicle is spaced apart from the deviating vehicle at a predetermined distance, it may be determined that the predetermined condition is satisfied.

For another example, the processor 130 may calculate possibility of collision of the deviating vehicle based on at least one of a deviating direction and a deviating speed of the deviating vehicle. When the possibility of collision is lower than a predetermined value, it may be determined that the predetermined condition is satisfied. The possibility of collision may be calculated by collectively considering the vehicle travel information generated from all the group vehicles included in the group.

The processor 130 may determine whether the deviation of the follow vehicle satisfies the predetermined condition based on the vehicle travel information received from the electric components (S510).

Specifically, the processor 130 may receive the vehicle travel information from one or more electric components provided in the vehicle via the communication unit 110, and determine whether the deviation of any one of the follow vehicles satisfies the predetermined condition based on the vehicle travel information.

The processor 130 may determine whether the deviation of the follow vehicle satisfies the predetermined condition based on the follow vehicle travel information received from at least one follow vehicle included in the group (S530).

Specifically, the processor 130 may receive the follow vehicle travel information from the follow vehicles via the communication unit 110, and determine whether the deviation of any one of the follow vehicles satisfies the predetermined condition based on the vehicle travel information and the follow vehicle travel information.

The processor 130 may determine whether the deviation of the deviating vehicle satisfies the predetermined condition by using only the follow vehicle travel information. When the processor 130 may not determine whether the deviation of the deviating vehicle satisfies the predetermined condition based on the vehicle travel information, the processor 130 may request the follow vehicle travel information from the follow vehicle included in the group.

When the deviation of the deviating vehicle satisfies a predetermined condition, the processor 130 may transmit a deviation approval message to the deviating vehicle (S550).

The deviating vehicle restricts control authority of the driver boarded on the deviating vehicle until the deviation approval message is received. For example, even when a steering wheel is operated, a driving direction is not changed, or a degree of change of a driving direction may be reduced to about 1/n. Even when an acceleration pedal is pressed or a brake is depressed, a speed of the vehicle may not be adjusted, or a degree of change of speed control may be reduced to about 1/n. Here, n denotes a natural number.

The control authority restricted to the driver to the deviating vehicle is released by the deviation approval message. The deviating vehicle releases the restriction of the control authority in response to the deviation approval message.

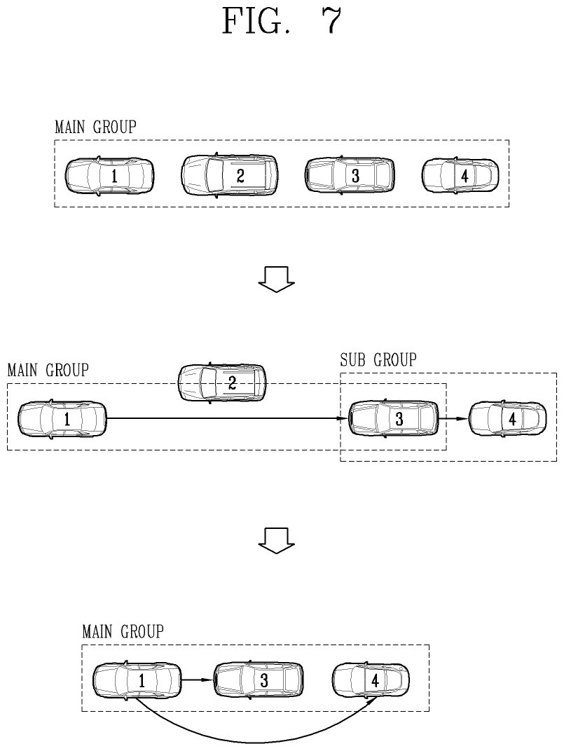

FIG. 6 is a flowchart for describing a method of setting a sub-group in response to occurrence of a deviating vehicle, and FIG. 7 is a conceptual diagram describing in more detail the method described in FIG. 6.

When a distance between platooning vehicles is widened due to deviation, it may be impossible to communicate with a part of platooning vehicles due to a physical limit of the leader vehicle. Further, a lot of resources may be consumed in generating a control message suitable for each of the follow vehicles due to the deviating vehicle. In order to use resources effectively while maintaining the group, the processor 130 may generate sub-groups as needed.

The processor 130 may set a sub-group, a sub-leader vehicle leading the sub-group, and a sub-follow vehicle following the sub-leader vehicle (S610).

For example, as shown in FIG. 7, a first vehicle may be a leader vehicle, and second to fourth vehicles may correspond to follow vehicles, and platooning may be performed. Then, the second vehicle may deviate from a group by changing a lane as a deviating vehicle. A processor of the first vehicle may generate, for at least one of the third vehicle and the fourth vehicle, a control message for controlling such that a distance from a preceding vehicle is changed until the deviation of the second vehicle is completed.

The processor 130 of the leader vehicle may select any one of the follow vehicles as the sub-leader vehicle based on at least one of a position, a type, a height, a length, and a speed of each follow vehicle. The sub-leader vehicle may be selected in collective consideration of fuel efficiency and communication efficiency, etc. of the sub-group.

It is possible to set as a sub-group from a follow vehicle positioned behind the deviating vehicle to a follow vehicle positioned at the last order of the group. In this case, as shown in FIG. 7, the third vehicle positioned behind the second vehicle which is the deviating vehicle is set as the sub-leader vehicle, and the sub-group is set from the third vehicle to the fourth vehicle located at a last order of the group. The fourth vehicle is set as the sub-follow vehicle following the sub-leader vehicle.

When the sub-group is set, transmitting of the vehicle travel information to the sub-follow vehicle may be restricted (S630).

In general, when a group is set, a leader vehicle transmits its own vehicle travel information to all follow vehicles. Each follow vehicle performs platooning based on the vehicle travel information of the leader vehicle.

As shown in FIG. 7, when a distance between vehicles is increased due to the deviation of the second vehicle, the vehicle travel information of a first communication may not be transmitted to the fourth vehicle due to limitation of a communication range. Further, it may be more effective for fuel efficiency and resource distribution that the third vehicle controls the fourth vehicle than that the first vehicle controls the fourth vehicle.

Therefore, when the sub-group is set, the leader vehicle transmits the vehicle travel information only to the sub-leader vehicle of the sub-group, and does not transmit the vehicle travel information to the sub-follow vehicle of the sub-group. In other words, when the sub-group is set, it is restricted that the vehicle travel information is transmitted to the sub-follow vehicle.

Instead, the sub-leader vehicle may transmit the vehicle travel information generated in the sub-leader vehicle to the sub-follow vehicle. The sub-follow vehicle performs sub-platooning based on the vehicle travel information of the sub-leader vehicle, instead of the vehicle travel information of the leader vehicle.

The sub-leader vehicle adjusts a distance from the preceding vehicle according to a control message of the leader vehicle. In a deviating process of the deviating vehicle, the deviating vehicle drives at a first distance apart, and when the deviation of the deviating vehicle is completed, the acceleration may be performed such that the deviating vehicle is spaced apart at a second distance shorter than the first distance.

When the sub-group is released, the transmitting of the vehicle travel information to the sub-follow vehicle may be resumed (S650).

When the deviation of the deviating vehicle is completed, the processor of the leader vehicle may transmit the vehicle travel information to the follow vehicle of the group and the sub-leader vehicle of the sub-group so as to narrow the vehicle distance again. When the distance between the respective vehicles included in the group is narrowed enough to perform the platooning, the sub-group is released.

The processor of the leader vehicle may release the sub-group based on a distance between the sub-leader vehicle and a vehicle positioned in front of the sub-leader vehicle. In other words, a reference distance for releasing the sub-group may be set, and the sub-group may be released when the distance between the sub-leader vehicle and the vehicle positioned in front of the sub-leader vehicle is within a reference distance.

When the sub-group is released, the vehicle travel information of the leader vehicle is transmitted to the sub-follow vehicle again. The sub-follow vehicle is changed to the follow vehicle again, and performs the platooning based on the vehicle travel information of the leader vehicle instead of the vehicle travel information of the sub-leader vehicle.

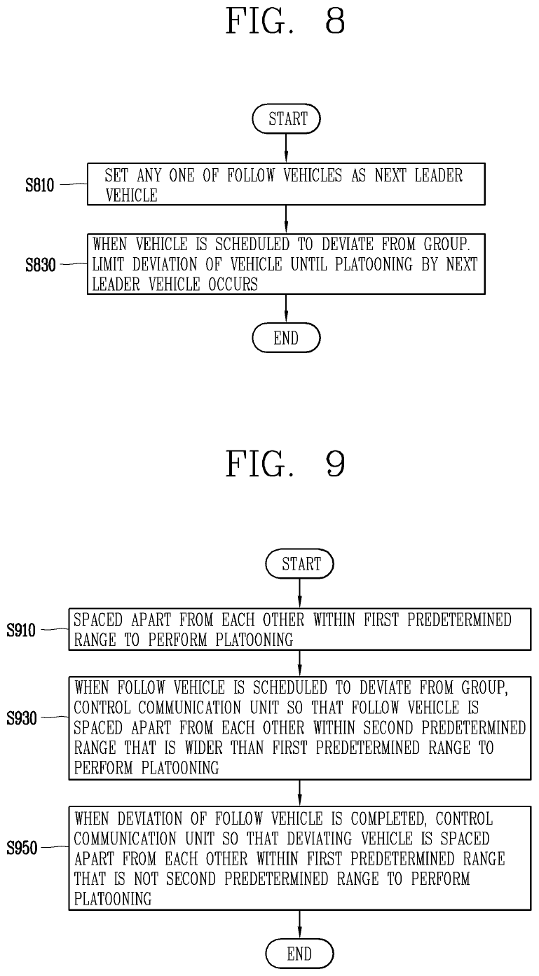

FIG. 8 is a flowchart for describing an operation of a vehicle control device when a leader vehicle deviates.

The group includes one leader vehicle and one or more follow vehicles. When the deviating vehicle is the leader vehicle, a risk of an accident in the platooning follow vehicle may occur. To prevent this, the processor of the leader vehicle may set a next leader vehicle.

The processor 130 may set any one of the follow vehicles included in the group as the next leader vehicle (S810).

At least one of the follow vehicles may be set as the next leader vehicle.

When deviation of the vehicle is scheduled in the group, the deviation of the vehicle may be restricted until platooning is performed by the next leader vehicle (S830).

For example, when the leader vehicle is scheduled to deviate, a role of the leader vehicle is transferred to the next leader vehicle. The next leader vehicle sets a communication channel with the follow vehicles, and transmits vehicle travel information of the next leader vehicle to the follow vehicles. The leader vehicle transmits the vehicle travel information of the leader vehicle to at least one follow vehicle until all the follow vehicles have started the platooning based on the vehicle travel information of the next leader vehicle.

The leader vehicle may be restricted from deviating from the group until the next leader vehicle becomes the leader vehicle. Further, the control authority assigned to the driver of the leader vehicle may be restricted.

The control authority of the driver boarded on the leader vehicle may be restricted until the next leader vehicle is switched to the leader vehicle. For example, even when a steering wheel is operated, a driving direction is not changed, or a degree of change of a driving direction may be reduced to about 1/n. Even when an acceleration pedal is pressed or a brake is depressed, a speed of the vehicle may not be adjusted, or a degree of change of speed control may be reduced to about 1/n. Here, n denotes a natural number.

FIG. 9 is a flowchart for describing a method of controlling an operation of platooning vehicles when a vehicle deviates.

The platooning vehicles included in the group are spaced apart from each other within a first predetermined range to perform the platooning (S910). Here, the platooning vehicles include a leader vehicle and a follow vehicle.

The first predetermined range is determined by a processor of the leader vehicle, and may vary depending on a characteristic of a road being traveled and/or a characteristic of the platooning vehicle included in the group.

For example, in a curve section, the first predetermined range may be set to be slightly wider, but in a straight line section, the first predetermined range may be set to be slightly narrower.

For another example, the first predetermined range may be set to be relatively wider when a size of the leader vehicle is a second range that is larger than a first range. As the size of the leader vehicle becomes larger, a size of a region less influenced by wind becomes larger, and thus the vehicle distance may be set slightly wider. In this case, the first predetermined range may be set differently for each follow vehicle. This is because vehicles positioned in front of each follow vehicle are different.

When the follow vehicle is scheduled to deviate from the group, the communication unit may be controlled so that the follow vehicle is spaced apart from each other within a second predetermined range that is wider than the first predetermined range to perform the platooning (S930).

The deviating vehicle of which deviation is scheduled may share a point and/or a time to which deviation starts to the leader vehicle. The leader vehicle may control the communication unit to perform the platooning so that at least one follow vehicle is spaced apart from each other within a second predetermined range wider than the first predetermined range before reaching the deviation point and/or the deviation time.

The second predetermined range may vary depending on a road on which the leader vehicle is driving. The second predetermined range may be longer in the curve section or a ramp section than in a case in which the road on which the leader vehicle is driving is the straight line section.

In addition, the second predetermined range may vary depending on a deviation characteristic of the deviating vehicle. Examples of spacing apart at different distances according to the deviation characteristic have been described with reference to FIG. 4, and the description is omitted.

When the deviation of the deviating vehicle is completed, the communication unit may be controlled so that the deviating vehicle is spaced apart from each other within the first predetermined range that is not the second predetermined range to perform the platooning (S950).

The leader vehicle may determine whether the deviation of the deviating vehicle has been completed by using at least one of the vehicle travel information and the follow vehicle travel information. When it is determined that the deviation has been completed, the communication unit is controlled so that the distance between the platooning vehicles is narrowed again.

When a deviating vehicle deviating from a group occurs, a safe deviation of the deviating vehicle may be induced by adjusting a distance between platooning vehicles while a group of the platooning vehicles is not released. In addition, since the distance between the platooning vehicles varies depending on a deviation characteristic of the deviating vehicle, stability of the platooning vehicles is further enhanced.

The foregoing present disclosure may be implemented as codes (an application or software) readable by a computer on a medium written by the program. The control method of the above-described autonomous vehicle may be implemented by codes stored in a memory or the like.

The computer-readable media may include all kinds of recording devices in which data readable by a computer system is stored. Examples of the computer-readable media may include ROM, RAM, CD-ROM, magnetic tape, floppy disk, and optical data storage device, and the like, and also include a device implemented in the form of a carrier wave (for example, transmission via the Internet). In addition, the computer may include a processor or controller. Accordingly, the detailed description thereof should not be construed as restrictive in all aspects but considered as illustrative. The scope of the invention should be determined by reasonable interpretation of the appended claims and all changes that come within the equivalent scope of the invention are included in the scope of the invention.

1. A vehicle control device for controlling a vehicle, the vehicle control device comprising:
a communication unit configured to communicate with one or more follow vehicles set as a group; and
a processor configured to transmit vehicle travel information via the communication unit so that platooning is performed with the one or more follow vehicles, wherein the processor, in response to any one of the follow vehicles deviating from the group, generates a control message so that at least one of the follow vehicles drives at different distances apart from each other according to a deviation characteristic of any one of the follow vehicles.

2. The vehicle control device of claim 1, wherein in response to the deviation characteristic satisfying a first deviation condition, the processor generates a control message so that at least one of vehicles drives at a first distance apart, and in response to the deviation characteristic satisfying a second deviation condition, the processor generates a control message so that at least one of follow vehicles drives at a second distance that is narrower than the first distance apart.

3. The vehicle control device of claim 2, wherein the first deviation condition is defined as any one of the follow vehicles deviating from the group at manual driving, and the second deviation condition is defined as any one of the follow vehicles deviating from the group at autonomous driving.

4. The vehicle control device of claim 2, wherein the first deviation condition is defined as any one of the follow vehicles deviating from the group according to a control of the processor, and the second deviation condition is defined as any one of the follow vehicles deviating from the group regardless of the control of the processor.

5. The vehicle control device of claim 1, wherein in response to the deviation of any one of the follow vehicles satisfying a predetermined condition, the processor transmits a deviation approval message to any one of the follow vehicles.

6. The vehicle control device of claim 5, wherein the processor receives the vehicle travel information from one or more electric components provided in the vehicle via the communication unit, and determines whether the deviation of any one of the follow vehicles satisfies the predetermined condition based on the vehicle travel information.

7. The vehicle control device of claim 6, wherein the processor receives follow vehicle travel information from the follow vehicles via the communication unit, and determines whether the deviation of any one of the follow vehicles satisfies the predetermined condition based on the vehicle travel information and the follow vehicle travel information.

8. The vehicle control device of claim 5, wherein control authority restricted to a driver boarded on any one of the follow vehicles is released by the deviation approval message.

9. The vehicle control device of claim 1, wherein the processor receives the vehicle travel information from one or more electric components provided in the vehicle via the communication unit, and determines whether the deviation characteristic satisfies the first deviation condition or the second deviation condition based on the vehicle travel information.

10. The vehicle control device of claim 1, wherein the processor determines whether the deviation characteristic satisfies the first deviation condition or the second deviation condition based on a message received from any one of the follow vehicles.

11. The vehicle control device of claim 1, wherein in response to any one of the follow vehicles deviating from the group, the processor sets a sub-group, a sub-leader vehicle leading the sub-group, and a sub-follow vehicle following the sub-leader vehicle.

12. The vehicle control device of claim 11, wherein when the sub-group is set, the processor limits transmitting of the vehicle travel information to the sub-follow vehicle.

13. The vehicle control device of claim 12, wherein when the sub-group is released, the transmitting of the vehicle travel information to the sub-follow vehicle is resumed.

14. The vehicle control device of claim 13, wherein the processor releases the sub-group based on a distance between the sub-leader vehicle and a vehicle positioned in front of the sub-leader vehicle.

15. The vehicle control device of claim 11, wherein the processor selects any one of the follow vehicles as the sub-leader vehicle based on at least one of a position, a type, a height, a length, and a speed of each follow vehicle.

16. The vehicle control device of claim 1, wherein the processor sets any one of the follow vehicles as a next leader vehicle, and when deviation of the vehicle is scheduled in the group, the deviation of the vehicle is restricted until platooning is performed by the next leader vehicle.

17. The vehicle control device of claim 16, wherein restriction of control authority assigned to a driver boarded on the vehicle is included in the restriction of the deviation of the vehicle.

18. The vehicle control device of claim 1, wherein when any one of the follow vehicles is scheduled to deviate from the group during platooning while being spaced apart from each other within a first predetermined range, the processor controls the communication unit so as to perform the platooning while being spaced apart from each other within a second predetermined range wider than the first predetermined range.

19. The vehicle control device of claim 18, wherein the second predetermined range varies depending on a road on which the vehicle is driving.

20. The vehicle control device of claim 18, wherein when deviation of the follow vehicle is completed, the processor controls the communication unit so that the deviating vehicle is spaced apart from each other within the first predetermined range that is not the second predetermined range to perform the platooning.
